(19) United States
(12) Patent Application Publication
(10) Pub. No.: US 2023/0419918 A1
(43) Pub. Date: Dec. 28, 2023

(54) METHOD FOR GENERATING CHROMATICITY CALIBRATION COMPENSATION TABLE AND MOBILE TERMINAL

(71) Applicants: HUIZHOU CHINA STAR OPTOELECTRONICS DESPLAY CO., LTD., Huizhou (CN); TCL CHINA STAR OPTOELECTRONICS TECHNOLOGY CO., LTD., Shenzhen (CN)

(72) Inventor: Lu Liu, Huizhou (CN)

(73) Assignees: HUIZHOU CHINA STAR OPTOELECTRONICS DISPLAY CO., LTD., Huizhou (CN); TCL CHINA STAR OPTOELECTRONICS TECHNOLOGY CO., LTD., Shenzhen (CN)

(21) Appl. No.: 17/816,096

(22) Filed: Jul. 29, 2022

(30) Foreign Application Priority Data
Jun. 28, 2022 (CN) 202210748564.8

(51) Int. Cl. G09G 3/36

(52) U.S. Cl. CPC G09G 3/3607; G09G 2320/0693; G09G 2320/0666; G09G 2360/16; G09G 2320/0295

(57) ABSTRACT

A method for generating a chromaticity calibration compensation table is provided. The table is applied to a display panel having a plurality of pixel units. Each of the pixel units has a plurality of primary color sub-pixels. The method includes acquiring luminance information of the display panel, wherein the luminance information at least includes a mapping relationship and predetermined luminance data, wherein the mapping relationship is between pieces of actual chromaticity information and output grayscales of each of the primary color sub-pixels; according to predetermined color information in a predetermined chromaticity system and the predetermined luminance data, calculating pieces of ideal chromaticity information that the display panel should have when the display panel displays target grayscales with an ideal display effect; and matching the pieces of the actual chromaticity information and the pieces of the ideal chromaticity information to generate the table. Production efficiencies of display panels are improved.

### CROSS-REFERENCE TO RELATED APPLICATION

This application claims priority to a Chinese Patent Application No. 202210748564.8 filed on Jun. 28, 2022, the disclosure of which is incorporated in their entirety by reference herein.

### FIELD OF DISCLOSURE

The present disclosure relates to a technical field of display panels, and more particularly to a method for generating a chromaticity calibration compensation table and a mobile terminal.

### BACKGROUND OF DISCLOSURE

With continuous development in electronic technology, the display panels are needed in more and more application scenarios. In order for a display panel to achieve an ideal display effect when the display panel displays a target grayscale, an output grayscale that each of primary color sub-pixels of the display panel should be configured with under the target grayscale needs to be acquired via the chromaticity calibration compensation table in the display panel. Each of the primary color sub-pixels is configured with the output grayscale.

However, in order to generate the chromaticity calibration compensation table in the prior art, it is generally necessary to have an operator with debugging experience assist in viewing an effect and debugging the chromaticity calibration compensation table manually, resulting in low production efficiencies of display panels.

### SUMMARY OF DISCLOSURE

In order to solve the aforementioned problem, the present disclosure provides the following technical solutions.

In a first aspect, the present disclosure provides a method for generating a chromaticity calibration compensation table, wherein the chromaticity calibration compensation table is applied to a display panel, and the generation method is applied to a first processor, wherein the display panel has a plurality of pixel units, and each of the pixel units has a plurality of primary color sub-pixels, and wherein the generation method at least includes:
an acquisition step of acquiring luminance information of the display panel, wherein the luminance information at least includes a mapping relationship and a plurality of predetermined luminance data, wherein the mapping relationship is between a plurality of pieces of actual chromaticity information and output grayscales of each of the primary color sub-pixels;
a calculation step of, according to predetermined color information in a predetermined chromaticity system, and the predetermined luminance data, calculating a plurality of pieces of ideal chromaticity information that the display panel should have when the display panel displays a plurality of target grayscales with an ideal display effect; and
a generating step of matching the pieces of the actual chromaticity information and the pieces of the ideal chromaticity information to generate the chromaticity calibration compensation table, wherein the chromaticity calibration compensation table indicates the output grayscale that each of the primary color sub-pixels should be configured with when the display panel displays each of the target grayscales with the ideal display effect;
wherein the first processor at least includes a calculation module, and an acquisition module and a generation module coupled to the calculation module, wherein the acquisition module is configured to perform the acquisition step, the calculation module is configured to perform the calculation step, and the generation module is configured to perform the generation step.

According to the generation method of an embodiment of the present disclosure, the step of acquiring luminance information of the display panel specifically includes:
measuring pieces of primary color chromaticity information that each of the primary color sub-pixels has when each of the primary color sub-pixels individually displays the output grayscales that each of the primary color sub-pixels is configured with;
respectively selecting and adding one piece of the pieces of the primary color chromaticity information of each of the primary color sub-pixels together multiple times, to obtain the mapping relationship between the pieces of the actual chromaticity information and the output grayscales of each of the primary color sub-pixels; and
using the mapping relationship as the luminance information of the display panel.

According to the generation method of an embodiment of the present disclosure, the output grayscales include a plurality of selected output grayscales and a plurality of interpolation output grayscales, wherein each adjacent two of the selected output grayscales are spaced apart by at least one of the interpolation output grayscales, and wherein the step of measuring pieces of primary color chromaticity information that each of the primary color sub-pixels has when each of the primary color sub-pixels individually displays the output grayscales that each of the primary color sub-pixels is configured with specifically includes:
measuring pieces of first primary color chromaticity information that each of the primary color sub-pixels has when each of the primary color sub-pixels individually displays the selected output grayscales that each of the primary color sub-pixels is configured with;
according to the pieces of the first primary color chromaticity information, deriving pieces of second primary color chromaticity information that each of the primary color sub-pixels has when each of the primary color sub-pixels individually displays the interpolation output grayscales that each of the primary color sub-pixels is configured with.

According to the generation method of an embodiment of the present disclosure, each piece of the pieces of the primary color chromaticity information includes a first stimulus value, a second stimulus value, and a third stimulus value, and wherein after the one piece of the pieces of the primary color chromaticity information of each of the primary color sub-pixels is respectively selected each time, the first stimulus value, the second stimulus value, and the third stimulus value in each piece of pieces of the primary color chromaticity information are added together in a one-to-one correspondence manner to acquire an actual first stimulus value, an actual second stimulus value, and an actual third stimulus value that are used as a piece of the actual chromaticity information.

According to the generation method of an embodiment of the present disclosure, the step of acquiring luminance information of the display panel further includes:
respectively acquiring a plurality of pieces of anchor chromaticity information of the display panel when the display panel is in full white display and full black display; and
using anchor second stimulus values in the pieces of the anchor chromaticity information as the predetermined luminance data in the luminance information of the display panel.

According to the generation method of an embodiment of the present disclosure, the step of, according to predetermined color information in a predetermined chromaticity system, and the predetermined luminance data, calculating a plurality of pieces of ideal chromaticity information that the display panel should have when the display panel displays a plurality of target grayscales with an ideal display effect specifically includes:
applying a first predetermined formula to the predetermined luminance data to calculate an ideal second stimulus value that the display panel should be configured with when the display panel displays each of the target grayscales with the ideal display effect;
applying second predetermined formulae to the predetermined color information in the predetermined chromaticity system and each of the ideal second stimulus values to calculate an ideal first stimulus value and an ideal third stimulus value corresponding to each of the ideal second stimulus values; and
using a plurality of sets of the corresponding ideal first stimulus values, ideal second stimulus values, and ideal third stimulus values as the pieces of the ideal chromaticity information, wherein the display panel has one piece of the pieces of the ideal chromaticity information when the display panel displays each of the target grayscales with the ideal display effect.

According to the generation method of an embodiment of the present disclosure, before the step of matching the pieces of the actual chromaticity information and the pieces of the ideal chromaticity information, the generation method further includes:
according to the actual first stimulus value, the actual second stimulus value, and the actual third stimulus value in each piece of the pieces of the actual chromaticity information, calculating a corresponding piece of actual color information; and
calculating a first difference between the piece of the actual color information of each piece of the pieces of the actual chromaticity information and the predetermined color information.

According to the generation method of an embodiment of the present disclosure, before the step of matching the pieces of the actual chromaticity information and the pieces of the ideal chromaticity information, the generation method further includes:

performing subtraction in a one-to-one correspondence manner between the actual first stimulus value, the actual second stimulus value, and the actual third stimulus value in each piece of the pieces of the actual chromaticity information and the ideal first stimulus value, the ideal second stimulus value, and the ideal third stimulus value in each piece of the pieces of the ideal chromaticity information, to obtain second differences.

According to the generation method of an embodiment of the present disclosure, in the step of matching the pieces of the actual chromaticity information and the pieces of the ideal chromaticity information, when there are a plurality of pieces of the actual chromaticity information that match a piece of the ideal chromaticity information, a piece of the actual chromaticity information with the first difference that is less is preferentially selected, and a piece of the actual chromaticity information with the second differences that are less is secondly selected.

In a second aspect, the present disclosure provides a mobile terminal, wherein the mobile terminal at least includes:
a display panel; and
a second processor coupled to the display panel, and configured to perform, for the display panel, the method for generating the chromaticity calibration compensation table according to any one of the aforementioned embodiments.

Advantageous effects of the present disclosure are as follows. The method for generating the chromaticity calibration compensation table is provided by the present disclosure. The chromaticity calibration compensation table is applied to the display panel. The display panel has the pixel units. Each of the pixel units has the primary color sub-pixels. The generation method includes acquiring the luminance information of the display panel, wherein the luminance information at least includes the mapping relationship and the predetermined luminance data, wherein the mapping relationship is between the pieces of actual chromaticity information and the output grayscales of each of the primary color sub-pixels; according to the predetermined color information in the predetermined chromaticity system, and the predetermined luminance data, calculating the pieces of ideal chromaticity information that the display panel should have when the display panel displays the target grayscales with the ideal display effect; and then matching the pieces of the actual chromaticity information and the pieces of the ideal chromaticity information to generate the chromaticity calibration compensation table, wherein the chromaticity calibration compensation table indicates the output grayscale that each of the primary color sub-pixels should be configured with when the display panel displays each of the target grayscales with the ideal display effect. The method for generating the chromaticity calibration compensation table provided by the present disclosure is executed by a machine, thereby effectively improving production efficiencies of display panels.

### DESCRIPTION OF DRAWINGS

In order to describe a technical solutions of the present disclosure more clearly, drawings required to be used by the embodiments of the present disclosure are briefly introduced below. Obviously, the drawings in the description below are only some embodiments of the present disclosure. With respect to persons skilled in the art, under a premise that inventive efforts are not made, other drawings can be obtained based on these drawings.

FIG. 1 is a schematic flowchart of a method for generating a chromaticity calibration compensation table according to some embodiments of the present disclosure.

FIG. 2 is a schematic further flowchart of the method for generating the chromaticity calibration compensation table according to some embodiments of the present disclosure.

FIG. 3 is a schematic structural diagram of a display panel according to some embodiments of the present disclosure.

FIG. 4 is a schematic further flowchart of a measurement sub-step in the method for generating the chromaticity calibration compensation table according to some embodiments of the present disclosure.

FIG. 5 is a schematic structural diagram of a mobile terminal according to some embodiments of the present disclosure.

FIG. 6 is a schematic further structural diagram of the mobile terminal according to some embodiments of the present disclosure.

FIG. 7 is a schematic structural diagram of a first processor according to some embodiments of the present disclosure.

### DETAILED DESCRIPTION OF EMBODIMENTS

Technical solutions in the embodiments of the present disclosure will be described clearly and completely hereinafter with reference to the accompanying drawings in the embodiments of the present disclosure. Apparently, the described embodiments are merely some rather than all embodiments of the present disclosure. All other embodiments obtained by persons skilled in the art on the basis of the embodiments of the present disclosure without creative efforts shall fall within the protection scope of the present disclosure.

In the description of the present disclosure, the following should be understood. The terms “first” and “second” are only used for description purpose, and cannot be considered as indicating or implying relative importance or implicitly pointing out the number of relevant technical features. Thus, features being respectively defined as “first” and “second” can each expressly or implicitly include at least one of the features. In the description of the present disclosure, the meaning of “a plurality of” is at least two, such as two and three, unless otherwise definitely and specifically defined.

In the description of the present disclosure, the following should be noted. Unless otherwise definitely specified and defined, the terms “install”, “connected”, “connection”, etc. should be interpreted broadly, for example, as a fixed connection, a detachable connection, or an integral connection; as a mechanical connection, an electrical connection, or a connection for communicating with each other; as being directly connected or being indirectly connected through an intervening medium; and as an internal connection between two elements or an operational relationship between two elements. To persons skilled in the art, the specific meanings of the aforementioned terms in the present disclosure can be appreciated on the basis of corresponding specific situations.

The publication of the following description provides many different embodiments or examples for implementing different structures of the present disclosure. In order to simplify the publication of the present disclosure, in the following description, components and configurations of particular examples are described. Of course, they are only examples, and do not aim at limiting the present disclosure. In addition, the present disclosure can repeat reference numerals and/or reference letters in different examples. The repetition is for the purposes of simplicity and clarity, and the repetition itself does not indicate relationships between methods and/or configurations of various embodiments. Furthermore, the present disclosure provides various particular process and material examples, but persons skilled in the art can think of application of other processes and/or use of other material.

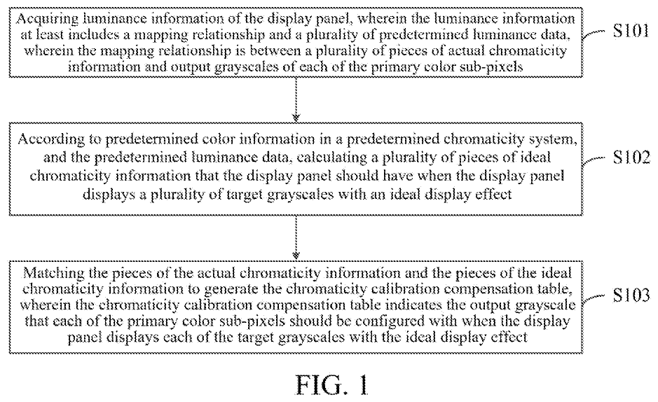

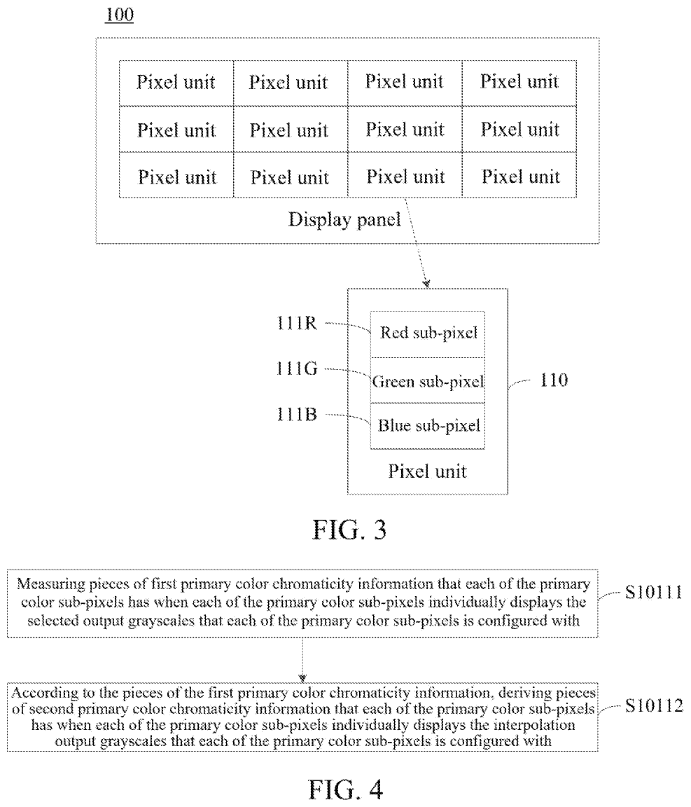

Referring to FIGS. 1 and 3, FIG. 1 is a schematic flowchart of a method for generating a chromaticity calibration compensation table according to some embodiments of the present disclosure. FIG. 3 is a schematic structural diagram of a display panel 100 according to some embodiments of the present disclosure. From the figure, each component of the present disclosure and relative positional relationship of each component can be intuitively seen.

It should be noted that the chromaticity calibration compensation table is applied to the display panel 100. As illustrated in FIG. 3, the display panel 100 has a plurality of pixel units 110. Each of the pixel units 110 has a plurality of primary color sub-pixels. The primary color sub-pixels include a red sub-pixel 111R, a green sub-pixel 111G, and a blue sub-pixel 111B.

As illustrated in FIG. 1, the generation method at least can include an acquisition step S101, a calculation step S102 and a generation step S103. Next, the above steps are described in detail.

In the acquisition step S101, luminance information of the display panel is acquired. The luminance information at least includes a mapping relationship and a plurality of predetermined luminance data, wherein the mapping relationship is between a plurality of pieces of actual chromaticity information and output grayscales of each of the primary color sub-pixels.

It should be noted that the mapping relationship acquired in the acquisition step S101 is a first basis for performing the subsequent generation step S103. And the predetermined luminance data acquired in the acquisition step S101 is a basis for performing the subsequent calculation step S102. Each mapping in the mapping relationship represents a piece of the actual chromaticity information that the display panel 100 has when the red sub-pixel 111R, the green sub-pixel 111G, and the blue sub-pixel 111B in each of the pixel units 110 of the display panel 100 are configured with the corresponding output grayscales for display. Specifically, acquisition methods of the mapping relationship include, but are not limited to acquiring the mapping relationship by one-by-one measurement, and acquiring the mapping relationship by measurement combined with derivation.

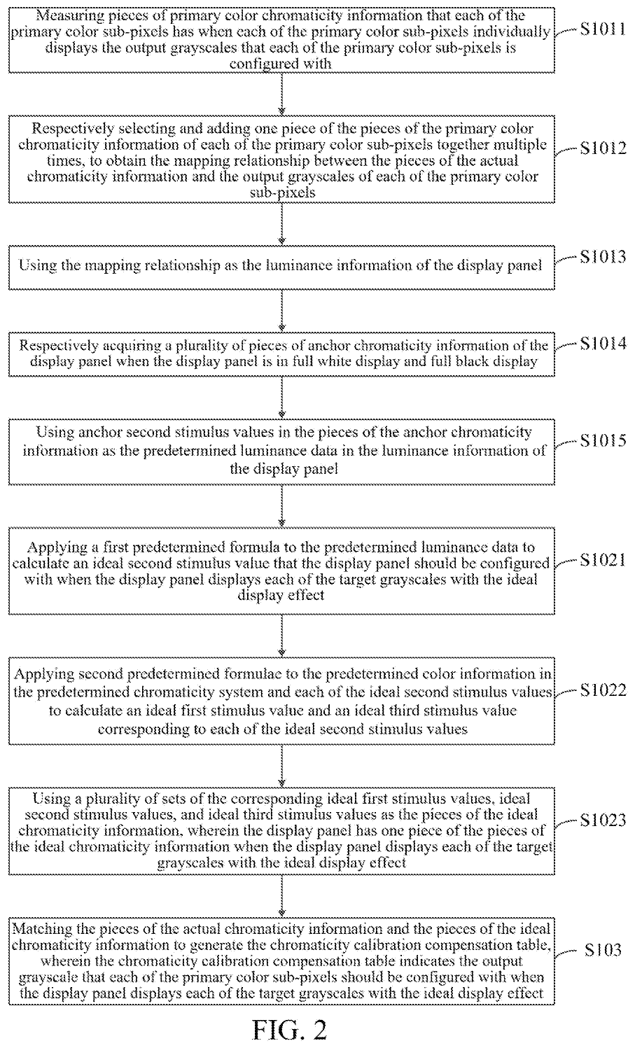

Referring to FIG. 2 next, FIG. 2 is a schematic further flowchart of the method for generating the chromaticity calibration compensation table according to some embodiments of the present disclosure. As illustrated in FIG. 2, in one embodiment, the acquisition method of the mapping relationship can specifically include the following steps:

In a first measurement sub-step S1011, pieces of primary color chromaticity information that each of the primary color sub-pixels has when each of the primary color sub-pixels individually displays the output grayscales that each of the primary color sub-pixels is configured with are measured.

In a calculation sub-step S1012, one piece of the pieces of the primary color chromaticity information of each of the primary color sub-pixels is respectively selected, and added together multiple times, to obtain the mapping relationship between the pieces of the actual chromaticity information and the output grayscales of each of the primary color sub-pixels.

In a first determination sub-step S1013, the mapping relationship is used as the luminance information of the display panel.

The following should be noted. It is taken as an example that each of the primary color sub-pixels has 4-bit output grayscales (i.e., the output grayscales include a 0th level output grayscale to a 15th level output grayscale, which have 16 levels in total). In the first measurement sub-step S1011, the following is specifically to be measured for example: the corresponding piece of the primary color chromaticity information when the red sub-pixel 111R is configured with any one level of the 0th level output grayscale to the 15th level output grayscale, and the green sub-pixel 111G and the blue sub-pixel 1111B are each configured with the 0th level output grayscale. That is, when the red sub-pixel 111R individually displays the output grayscales that the red sub-pixel 111R is configured with, a total of 16 pieces of red chromaticity information are acquired. Similarly, when the green sub-pixel 111G individually displays the output grayscales that the green sub-pixel 111G is configured with, a total of 16 pieces of green chromaticity information are acquired. When the blue sub-pixel 111B individually displays the output grayscales that the blue sub-pixel 111B is configured with, a total of 16 pieces of blue chromaticity information are acquired.

Further, in the calculation sub-step S1012, a specific calculation method is as follows: one piece of the 16 pieces of the red chromaticity information, one piece of the 16 pieces of the green chromaticity information, and one piece of the 16 pieces of the blue chromaticity information are selected and added together each time, and a result of each addition is used as one piece of the actual chromaticity information. That is, a total number of the pieces of the actual chromaticity information is C₁₆¹ C₁₆¹ C₁₆¹=4096.

The following should be noted. As mentioned above, the mapping relationship can be acquired by the measurement combined with the derivation in addition to the one-by-one measurement. For example, some output grayscales can be selected from the output grayscales as selected output grayscales, and remaining output grayscales are used as interpolation output grayscales. As illustrated in FIG. 4, the first measurement sub-step S1011 can specifically include the following steps:

In an actual measurement sub-step S10111: pieces of first primary color chromaticity information that each of the primary color sub-pixels has when each of the primary color sub-pixels individually displays a plurality of selected output grayscales that each of the primary color sub-pixels is configured with are measured.

In a derivation sub-step S10112, according to the pieces of the first primary color chromaticity information, pieces of second primary color chromaticity information that each of the primary color sub-pixels has when each of the primary color sub-pixels individually displays a plurality of interpolation output grayscales that each of the primary color sub-pixels is configured with are derived.

The following should be noted. It is still taken as an example that each of the primary color sub-pixels has 4-bit output grayscales. A 0th level output grayscale, a 4th level output grayscale, an 8th level output grayscale, and a 12th level output grayscale can be selected to be used as the selected output grayscales. That is, a 1st level output grayscale to a 3rd level output grayscale, a 5th level output grayscale to a 7th level output grayscale, a 9th level output grayscale to an 11th level output grayscale, and a 13th level output grayscale to a 15th level output grayscale are the interpolation output grayscales.

That is, in the actual measurement sub-step S10111, the pieces of first primary color chromaticity information that are measured include: 4 pieces of red chromaticity information that the red sub-pixel 111R has when the red sub-pixel 111R individually displays the selected output grayscales that the red sub-pixel 111R is configured with; 4 pieces of green chromaticity information that the green sub-pixel 111G has when the green sub-pixel 111G individually displays the selected output grayscales that the green sub-pixel 111G is configured with; and 4 pieces of blue chromaticity information that the blue sub-pixel 111B has when the blue sub-pixel 111B individually displays the selected output grayscales that the blue sub-pixel 111B is configured with.

Further, in the derivation sub-step S10112, according to the 4 pieces of the red chromaticity information, the 4 pieces of the green chromaticity information, and the 4 pieces of the blue chromaticity information that are measured, 12 pieces of the red chromaticity information that the red sub-pixel 111R has when the red sub-pixel 111R individually displays the interpolation output grayscales that the red sub-pixel 111R is configured with, 12 pieces of the green chromaticity information that the green sub-pixel 111G has when the green sub-pixel 111G individually displays the interpolation output grayscales that the green sub-pixel 111G is configured with, and 12 pieces of the blue chromaticity information that the blue sub-pixel 111B has when the blue sub-pixel 111B individually displays the interpolation output grayscales that the blue sub-pixel 111B is configured with are derived.

Specifically, derivation methods include, but are not limited to linear derivation and derivation according to a display characteristic curve of the display panel 100.

Specifically, in the above example, each adjacent two of the selected output grayscales are spaced apart by the interpolation output grayscales. It should be understood that in other examples of the present disclosure, each adjacent two of selected output grayscales can be spaced apart by at least one interpolation output grayscale.

Specifically, in the above example, for each of the primary color sub-pixels, a number and levels of the selected output grayscales are exactly same and a number and levels of the interpolation output grayscales are exactly same. It should be understood that in other examples of the present disclosure, for each of the primary color sub-pixels, a number and levels of the selected output grayscales can be not completely same or completely different, and a number and levels of the interpolation output grayscales can be not completely same or completely different.

For example, a 0th level output grayscale and a 4th level output grayscale can be selected to be used as the selected output grayscales of the red sub-pixel 111R, and remaining output grayscales are used as the interpolation output grayscales of the red sub-pixel 111R. At the same time, a 1st level output grayscale, a 3rd level output grayscale, and a 5th level output grayscale can be selected to be used as the selected output grayscales of the green sub-pixel 111G, and remaining output grayscales are used as the interpolation output grayscales of the green sub-pixel 111G. At the same time, a 2nd level output grayscale, the 4th level output grayscale, a 6th level output grayscale, and an 8th level output grayscale can be selected to be used as the selected output grayscales of the blue sub-pixel 111B, and remaining output grayscales are used as the interpolation output grayscales of the blue sub-pixel 111B. That is, embodiments of the present disclosure do not limit this.

The following should be further noted. Each piece of the pieces of the primary color chromaticity information mentioned above includes a first stimulus value, a second stimulus value, and a third stimulus value. The first stimulus value, the second stimulus value, and the third stimulus value represent measures of degrees of the tri-primary color (red, green, and blue) stimulation in a human retina. Further, when each of the primary color sub-pixels (e.g., the red sub-pixel 111R) individually displays, the display not only can result in red stimulation in the human retina, but also can result in green and blue stimulations in the human retina.

Specifically, it is still taken as an example that each of the primary color sub-pixels has 4-bit output grayscales. When the red sub-pixel 111R is configured with a 1th level output grayscale, a corresponding 0th level red chromaticity information can be represented as R0=(X_{R0}, Y_{R0}, Z_{R0}). Similarly, when the green sub-pixel 111G is configured with a 1st level output grayscale, a corresponding 1st level green chromaticity information can be represented as G1=(X_{G1}, Y_{G1}, Z_{G1}). Similarly, when the blue sub-pixel 111B is configured with a 2nd level output grayscale, a corresponding 2nd level blue chromaticity information can be represented as B2=(X_{B2}, Y_{B2}, Z_{B2}).

Specifically, the following table 1 shows exemplary magnitudes of a first stimulus value X_{R}, a second stimulus value Y_{R}, and a third stimulus value Z_{R} that each of a 1th level red chromaticity information R0, a 4th level red chromaticity information R4, an 8th level red chromaticity information R8, and a 12th level red chromaticity information R12 has, and corresponding levels of the output grayscales that the red sub-pixel 111R, the green sub-pixel 111G, and the blue sub-pixel 111B are configured with.

TABLE 1

| | | | | red sub- | green sub- | blue sub- |
|---|---|---|---|---|---|---|
| | X_{R} | Y_{R} | Z_{R} | pixel 111R | pixel 111G | pixel 111B |
| R0 | 0.09 | 0.06 | 0.08 | 0th level | 0th level | 0th level |
| | | | | output | output | output |
| | | | | grayscale | grayscale | grayscale |
| R4 | 5.7 | 3.03 | 0.32 | 4th level | 0th level | 0th level |
| | | | | output | output | output |
| | | | | grayscale | grayscale | grayscale |
| R8 | 24.2 | 12.83 | 1.06 | 8th level | 0th level | 0th level |
| | | | | output | output | output |
| | | | | grayscale | grayscale | grayscale |
| R12 | 56.6 | 29.99 | 2.14 | 12th level | 0th level | 0th level |
| | | | | output | output | output |
| | | | | grayscale | grayscale | grayscale |

Further, in the calculation sub-step S1012 mentioned above, after the one piece of the pieces of the primary color chromaticity information of each of the primary color sub-pixels is respectively selected each time, the first stimulus value, the second stimulus value, and the third stimulus value in each piece of pieces of the primary color chromaticity information are added together in a one-to-one correspondence manner to acquire an actual first stimulus value, an actual second stimulus value, and an actual third stimulus value that are used as a piece of the actual chromaticity information.

For example, after for example, a 1th level red chromaticity information, a 1st level green chromaticity information, and a 2nd level blue chromaticity information are respectively selected from the 16 pieces of the red chromaticity information, the 16 pieces of the green chromaticity information, and the 16 pieces of the blue chromaticity information, one piece of the actual chromaticity information acquired through calculation can be represented as R0G1B2=(X_{R0}+X_{G1}+X_{B2}, Y_{R0}+Y_{G1}+Y_{B2}, Z_{R0}+Z_{G1}+Z_{B2}), where the actual first stimulus value is X_{R0}+X_{G1}+X_{B2}, the actual second stimulus value is Y_{R0}+Y_{G1}+Y_{B2}, and the actual third stimulus value is Z_{R0}+Z_{G1}+Z_{B2}.

Further, referring still to FIG. 2, as illustrated in FIG. 2, the acquisition step S101 can further include the following steps:

In a second measurement sub-step S1014: a plurality of pieces of anchor chromaticity information of the display panel when the display panel is in full white display and full black display are respectively acquired.

In a second determination sub-step S1015: anchor second stimulus values in the pieces of the anchor chromaticity information are used as the predetermined luminance data in the luminance information of the display panel.

The following should be noted. It is still taken as an example that each of the primary color sub-pixels has 4-bit output grayscales. When the display panel 100 is in the full white display, the red sub-pixel 111R, the green sub-pixel 111G, and the blue sub-pixel 111B are each configured with a 15th level output grayscale. In this display state, the piece of the anchor chromaticity information of the display panel 100 can be represented as R15G15B15=(X_{R15}+X_{G15}+X_{B15}, Y_{R15}+Y_{G15}+Y_{B15}, Z_{R15}+Z_{G15}+Z_{B15}). Similarly, when the display panel 100 is in the full black display, the red sub-pixel 111R, the green sub-pixel 111G, and the blue sub-pixel 111B are each configured with a 1th level output grayscale. In this display state, the piece of the anchor chromaticity information of the display panel 100 can be represented as R0G0B0=(X_{R0}+XG0+XB0, Y_{R0}+YG0+YB0, Z_{R0}+ZG0+ZB0).

Further, in the second determination sub-step S1015, the anchor second stimulus values Y_{R15}+Y_{G15}+Y_{B15} and Y_{R0}+YG0+YB0 are used as the predetermined luminance data in the luminance information of the display panel 100.

The following should be noted. Although, in the present example, the second measurement sub-step S1014 to the second determination sub-step S1015 are positioned after the first measurement sub-step S1011 to the first determination sub-step S1013, the present disclosure does not limit order of the first measurement sub-step S1011 to the second determination sub-step S1015.

The acquisition step S101 mentioned above describes how to combine the measurement and the calculation to acquire the mapping relationship and the predetermined luminance data of the display panel 100. Next, referring still to FIG. 1, after the acquisition step S101, the following steps can be further included:

In the calculation step S102, according to predetermined color information in a predetermined chromaticity system, and the predetermined luminance data, a plurality of pieces of ideal chromaticity information that the display panel should have when the display panel displays a plurality of target grayscales with an ideal display effect are calculated.

In the generation step S103, the pieces of the actual chromaticity information and the pieces of the ideal chromaticity information are matched to generate the chromaticity calibration compensation table. The chromaticity calibration compensation table indicates the output grayscale that each of the primary color sub-pixels should be configured with when the display panel displays each of the target grayscales with the ideal display effect.

It should be noted that the pieces of the ideal chromaticity information acquired in the calculation step S102 are a second basis for performing the subsequent generation step S103. Specifically, the “target grayscales” in the calculation step S102 are different from the “output grayscales” in the acquisition step S101. Next, it is taken as an example that the display panel 100 has 2-bit target grayscales (i.e., the target grayscales include a 1th level target grayscale to a 3rd level target grayscale, which have 4 levels in total). In the calculation step S102, the following is to be calculated: the piece of the ideal chromaticity information (specifically, an ideal first stimulus value, an ideal second stimulus value, and an ideal third stimulus value) that the display panel 100 should have when the display panel 100 displays any one of the 0th level target grayscale to the 3rd level target grayscale with the ideal display effect.

The following should be noted. In the embodiments of the present disclosure, the output grayscales have more levels than the target grayscales. In this way, a number of the pieces of the actual chromaticity information is greater than a number of the pieces of the ideal chromaticity information so that matching accuracy in the subsequent generation step S103 is increased. Thus, accuracy of the generated chromaticity calibration compensation table can be improved. Specifically, in the embodiments of the present disclosure, a number of levels of the output grayscales is 2^{N} times a number of levels of the target grayscales.

Specifically, referring still to FIG. 2, as illustrated in FIG. 2, the calculation step S102 can specifically include the following steps:

In a first conversion sub-step S1021: a first predetermined formula is applied to the predetermined luminance data to calculate an ideal second stimulus value that the display panel should be configured with when the display panel displays each of the target grayscales with the ideal display effect.

In a second conversion sub-step S1022, second predetermined formulae are applied to the predetermined color information in the predetermined chromaticity system and each of the ideal second stimulus values to calculate an ideal first stimulus value and an ideal third stimulus value corresponding to each of the ideal second stimulus values.

In a third determination sub-step S1023: a plurality of sets of the corresponding ideal first stimulus values, ideal second stimulus values, and ideal third stimulus values are used as the pieces of the ideal chromaticity information, wherein the display panel has one piece of the pieces of the ideal chromaticity information when the display panel displays each of the target grayscales with the ideal display effect.

The following should be noted. It is taken as an example that the display panel 100 has 2-bit target grayscales. In the embodiments of the present disclosure, the anchor second stimulus values Y_{R15}+Y_{G15}+Y_{B15} and Y_{R0}+YG0+Y_{B0} respectively are a 3rd level ideal second stimulus value Y3 and a 1th level ideal second stimulus value Y0 that the display panel 100 should have when the display panel 100 displays a 3rd level target grayscale and a 1th level target grayscale with the ideal display effect. Specifically, in the first conversion sub-step S1021, the first predetermined formula can be:

$$\frac{Yn - Y 0}{Y 3 - Y 0} = {( \frac{n}{3} )}^{2.2}$$

where 0<n<3. According to the first predetermined formula, a 1st level ideal second stimulus value and a 2nd ideal second stimulus value that the display panel 100 should have when the display panel 100 displays a 1st level target grayscale and a 2nd level target grayscale with the ideal display effect can be calculated.

Further, in the embodiments of the present disclosure, the predetermined chromaticity system in the second conversion sub-step S1022 can be a CIE1931-XYZ chromaticity system. In the chromaticity system, color coordinates (x, y, z) and a first stimulus value X, a second stimulus value Y, and a third stimulus value Z satisfy the following relations A:

$$x = \frac{X}{X + Y + Z} ; \\ y = \frac{Y}{X + Y + Z} ; \\ z = \frac{Z}{X + Y + Z} ; \\ x : y : z = X : Y : Z ; \\ x + y + z = 1$$

Further, by converting the relations A, the second predetermined formulae in the second conversion sub-step S1022 can be obtained:

$$X = \frac{xY}{y} ; \\ Z = \frac{( 1 - x - y ) Y}{y}$$

The following should be noted. In the second conversion sub-step S1022, the predetermined color information is a set of color coordinates selected in the chromaticity system. The set of color coordinates is a reference standard for calculating the ideal chromaticity information. That is, when a different set of color coordinates in a chromaticity system same as or different from the chromaticity system in the present example is selected, calculated ideal chromaticity information is also different. Further, when the chromaticity calibration compensation table is generated, a reference standard for each of the target grayscales of the display panel 100 should be consistent. That is, in a process of calculating the ideal first stimulus value, and the ideal third stimulus value in the ideal chromaticity information of the display panel 100 for each of the target grayscales L of the display panel 100 information, values of the set of color coordinates are same.

Specifically, the following table 2 shows, for each of the target grayscales L of the display panel 100, exemplary magnitudes of the ideal first stimulus value X, the ideal second stimulus value Y, and the ideal third stimulus value Z in the ideal chromaticity information of the display panel 100 that are calculated.

TABLE 2

| | X | Y | Z | x | y |
|---|---|---|---|---|---|
| L0 | X0 = 0.15 | Y0 = 0.16 | Z0 = 0.17 | 0.313 | 0.331 |
| L1 | X1 = 12.31 | Y1 = 13.02 | Z1 = 14.00 | 0.313 | 0.331 |
| L2 | X2 = 56.03 | Y2 = 59.25 | Z2 = 63.72 | 0.313 | 0.331 |
| L3 | X3 = 136.49 | Y3 = 144.34 | Z3 = 155.24 | 0.313 | 0.331 |

The following should be noted. Before “the pieces of the actual chromaticity information and the pieces of the ideal chromaticity information are matched” in the generation step S103, the following steps need to be further performed:

In an actual color information calculation step, according to the actual first stimulus value, the actual second stimulus value, and the actual third stimulus value in each piece of the pieces of the actual chromaticity information, a corresponding piece of actual color information is calculated.

In a first difference calculating step, a first difference between the piece of the actual color information of each piece of the pieces of the actual chromaticity information and the predetermined color information is calculated.

In a second difference calculation step, a subtraction in a one-to-one correspondence manner is performed between the actual first stimulus value, the actual second stimulus value, and the actual third stimulus value in each piece of the pieces of the actual chromaticity information and the ideal first stimulus value, the ideal second stimulus value, and the ideal third stimulus value in each piece of the pieces of the ideal chromaticity information, to obtain second differences.

Specifically, in a process of performing the “actual color information calculation step”, the corresponding piece of the actual color information can be obtained by applying the relations A to the actual first stimulus value, the actual second stimulus value, and the third stimulus value in each piece of the pieces of the actual chromaticity information. In the “first difference calculating step”, the first difference between each piece of the pieces of the actual color information and the predetermined color information (e.g., x=0.313, y=0.331) is calculated. The first difference represents a first degree of matching between each piece of the pieces of the actual chromaticity information and each piece of the pieces of the ideal chromaticity information.

Further, in the “second difference calculation step”, the second differences between the stimulus values in each piece of the pieces of the actual chromaticity information and the stimulus values in each piece of the pieces of the ideal chromaticity information are calculated. The second differences represent a second degree of matching between each piece of the pieces of the actual chromaticity information and each piece of the pieces of the ideal chromaticity information.

Further, in a process of performing the generation step S103, when there are a plurality of pieces of the actual chromaticity information that can match a piece of the ideal chromaticity information, i.e., when the first difference and the second differences between each piece of the pieces of the actual chromaticity information and the same piece of the ideal chromaticity information both fall within valid error ranges, a piece of the actual chromaticity information with the first difference that is less is preferentially selected as a matching target for the piece of the ideal chromaticity information. If the first difference of each piece of the pieces of the actual chromaticity information is equal to each other, then a piece of the actual chromaticity information with the second differences that are less is selected as a matching target for the piece of the ideal chromaticity information.

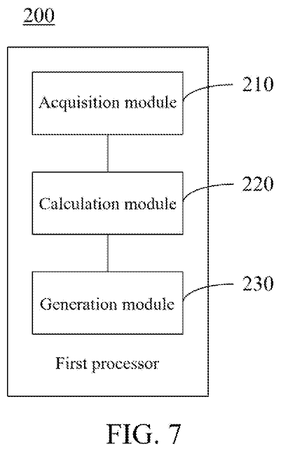

Further, referring to FIG. 7, FIG. 7 is a schematic structural diagram of a first processor 200 according to some embodiments of the present disclosure. The method for generating the chromaticity calibration compensation table mentioned above is applied to the first processor 200. From the figure, each component of the present disclosure and relative positional relationship of each component can be intuitively seen.

As illustrated in FIG. 7, the first processor 200 at least include a calculation module 220, and an acquisition module 210 and a generation module 230 coupled to the calculation module 220. The acquisition module 210 is configured to perform the acquisition step S101 and each sub-step of the acquisition step S101 mentioned above. The calculation module 220 is configured to perform the calculation step S102 and each sub-step of the calculation step S102 mentioned above. The generation module 230 is configured to perform the generation step S103 and each sub-step of the generation step S103 mentioned above.

According to the foregoing content, the method for generating the chromaticity calibration compensation table is provided by the present disclosure. The chromaticity calibration compensation table is applied to the display panel. The display panel has the pixel units. Each of the pixel units has the primary color sub-pixels. The generation method includes acquiring the luminance information of the display panel, wherein the luminance information at least includes the mapping relationship and the predetermined luminance data, wherein the mapping relationship is between the pieces of actual chromaticity information and the output grayscales of each of the primary color sub-pixels; according to the predetermined color information in the predetermined chromaticity system, and the predetermined luminance data, calculating the pieces of ideal chromaticity information that the display panel should have when the display panel displays the target grayscales with the ideal display effect; and then matching the pieces of the actual chromaticity information and the pieces of the ideal chromaticity information to generate the chromaticity calibration compensation table, wherein the chromaticity calibration compensation table indicates the output grayscale that each of the primary color sub-pixels should be configured with when the display panel displays each of the target grayscales with the ideal display effect. The method for generating the chromaticity calibration compensation table provided by the present disclosure is executed by a machine, thereby effectively improving production efficiencies of display panels.

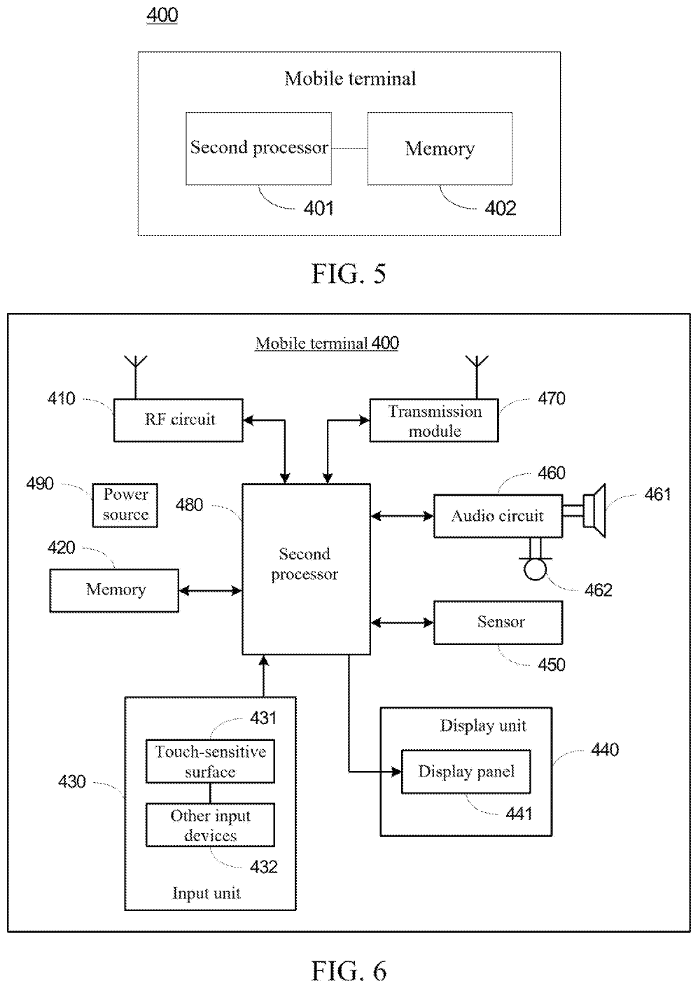

Referring to FIG. 5, FIG. 5 is a schematic structural diagram of a mobile terminal 400 according to some embodiments of the present disclosure. The mobile terminal 400 can be a smart phone, a tablet computer, or the like. From the figure, each component of the present disclosure and relative positional relationship of each component can be intuitively seen.

As illustrated in FIG. 5, the mobile terminal 400 includes a display panel (not illustrated), a second processor 401, and a memory 402. The second processor 401 is coupled to the memory 402 and the display panel. The display panel can be the display panel 100 mentioned above.

The second processor 401 is a control center of the mobile terminal 400, is connected to all parts of an entirety of the mobile terminal by various interfaces and lines, and by running or loading application programs stored in the memory 402, and calling data stored in the memory 402, performs various functions of the mobile terminal and process the data to monitor the mobile terminal as a whole.

Specifically, the second processor 401 is configured to perform chromaticity calibration compensation operations on the display panel according to the chromaticity calibration compensation table generated by the method for generating the chromaticity calibration compensation table mentioned above. The chromaticity calibration compensation operations can specifically include the following steps:

A target grayscale of the display panel is acquired.

Output grayscales that a plurality of primary color sub-pixels should be configured with and that correspond to the target grayscale is looked up in the chromaticity calibration compensation table.

Specifically, in the embodiments of the present disclosure, the primary color sub-pixels include a red sub-pixel 111R, a green sub-pixel 111G, and a blue sub-pixel 111B.

Specifically, in the embodiments of the present disclosure, a number of output grayscale levels is more than that of target grayscale levels. Specifically, the number of output grayscale levels is 2^{N} times the number of target grayscale levels.

Specifically, in the embodiments of the present disclosure, the display panel can be a liquid crystal display (LCD) panel.

Referring to FIG. 6, FIG. 6 is a schematic structural diagram of details of the mobile terminal 400 according to some embodiments of the present disclosure. The mobile terminal 400 can be a smart phone, a tablet computer, or the like. From the figure, each component of the present disclosure and relative positional relationship of each component can be intuitively seen.

FIG. 6 illustrates a specific structural block diagram of the mobile terminal 400 according to some embodiments of the present disclosure. Referring to FIG. 6, the mobile terminal 400 can include components such as a radio frequency (RF) circuit 410, a memory 420 including one or more computer-readable storage media, an input unit 430, a display unit 440, a sensor 450, an audio circuit 460, a transmission module 470 (e.g., Wireless Fidelity (Wi-Fi)), a second processor 480 including one or more processing cores, and a power supply 490. Those skilled in the art can understand that the structure of the mobile terminal illustrated in FIG. 6 does not constitute a limitation on the mobile terminal. The mobile terminal can include more or fewer components than those shown in the drawings. Or some of the components can be combined. Or different components can be arranged.

The RF circuit 410 is used to receive and send electromagnetic waves and achieve mutual conversion between the electromagnetic waves and electrical signals, to communicate with a communication network or other equipment. The RF circuit 410 can include various existing circuit elements for performing these functions, e.g., an antenna, an RF transceiver, a digital signal processor, an encryption/decryption chip, a subscriber identity module (SIM) card, and a memory. The RF circuit 410 can communicate with various networks such as the Internet, an intranet, and a wireless network, or communicate with other devices through the wireless network. The wireless network can include a cellular telephone network, a wireless local area network, or a metropolitan area network. The wireless network can use various communication standards, protocols and technologies, including but not limited to the Global System for Mobile Communication (GSM), Enhanced Data GSM Environment (EDGE), Wideband Code Division Multiple Access (WCDMA), Code Division Multiple Access (CDMA), Time Division Multiple Access (TDMA), Wireless Fidelity (Wi-Fi) (such as the Institute of Electrical and Electronics Engineers standards IEEE 802.11a, IEEE 802.11b, IEEE802.11g and/or IEEE 802.11n), Voice over Internet Protocol (VoIP), Worldwide Interoperability for Microwave Access (Wi-Max), other protocols for mail, instant messaging, and short messaging, and any other suitable communication protocols, even those protocols that have not yet been developed.

The memory 420 can be used to store software programs and modules, such as the program instructions corresponding to the audio power amplifier control method mentioned above. The second processor 480 executes various functional applications and data processing by running software programs and modules stored in the memory 420. That is, functions such as obtaining a frequency of an information transmission signal transmitted by the mobile terminal 400 and generating an interference signal can be achieved. The memory 420 can include a high-speed random access memory, and can further include a non-volatile memory, such as one or more magnetic storage devices, a flash memory, or other non-volatile solid-state memory. In some examples, the memory 420 can further include memories disposed remotely with respect to the second processor 480, and these remote memories can be connected to the mobile terminal 400 through a network. Examples of the network include, but are not limited to, the Internet, an intranet, a local area network, a mobile communication network, and combinations thereof.

The input unit 430 can be used to receive inputted numeric or character information, and generate input signals of a keyboard, a mouse, a joystick, an optical or a trackball, which are related to user settings and function control. Specifically, the input unit 430 can include a touch-sensitive surface 431 and other input devices 432. The touch-sensitive surface 431, also known as a touch display or a touchpad, can collect touch operations of a user on or near it (e.g., the user uses a finger, a stylus, or any suitable object or accessory to operate on or near the touch-sensitive surface 431), and drive a corresponding connection device according to a preset program. Optionally, the touch-sensitive surface 431 can include two parts, which are a touch detection device and a touch controller. The touch detection device detects the user's touch position, and detects the signal brought by a touch operation, and transmits the signal to the touch controller; and the touch controller receives touch information from the touch detection device, converts the touch information into contact coordinates, and then sends the contact coordinates to the second processor 480 and is capable of receiving commands from the second processor 480 and executing them. In addition, multiple types such as resistive, capacitive, infrared, and surface acoustic wave can be used to implement the touch-sensitive surface 431. In addition to the touch-sensitive surface 431, the input unit 430 can further include the other input devices 432. Specifically, the other input devices 432 can include, but are not limited to, one or more of the following: a physical keyboard, function keys (such as a volume control key and a switch key), a trackball, a mouse, a joystick, and the like.

The display unit 440 can be used to display information inputted by the user or information provided to the user and various graphical user interfaces of the mobile terminal 400. These graphical user interfaces can be composed of graphics, text, icons, videos, and any combination thereof. The display unit 440 can include a display panel 441. Optionally, the display panel 441 can be configured in a form of an LCD or an organic light emitting diode (OLED). Further, the touch-sensitive surface 431 can cover the display panel 441. When the touch-sensitive surface 431 detects a touch operation on or near the touch-sensitive surface 331, the touch-sensitive surface 431 transmits the touch operation to the second processor 480, to determine a type of a touch event. The second processor 480 then provides a corresponding visual output on the display panel 441 according to the type of the touch event. Although, in the figure, the touch-sensitive surface 431 and the display panel 441 are used as two separate components to implement input and output functions, in some embodiments, the touch-sensitive surface 431 and the display panel 441 can be integrated to implement input and output functions.

The mobile terminal 400 can further include at least one sensor 450, such as a light sensor, a motion sensor, and other sensors. Specifically, the light sensor can include an ambient light sensor and a proximity sensor. The ambient light sensor can adjust luminance of the display panel 441 according to luminance of ambient light. The proximity sensor can generate interruption when a cover is flipped to be closed or to turn off. As a kind of motion sensors, a gravity acceleration sensor can detect a magnitude of acceleration in all directions (generally three axes). It can detect a magnitude and a direction of gravity when it is stationary. It can be used for applications that recognize a pose of a mobile phone (e.g., switching between a horizontal screen and a vertical screen, a related game, and magnetometer pose calibration), and vibration recognition related functions (such as a pedometer, and tapping). For the mobile terminal 400, other sensors such as a gyroscope, a barometer, a hygrometer, a thermometer, and an infrared sensor can be further configured, and details are omitted here.

The audio circuit 460, a speaker 461, and a microphone 462 can provide an audio interface between the user and the mobile terminal 400. The audio circuit 460 can transmit electrical signals converted from received audio data to the speaker 461, and the speaker 461 converts the electrical signals into sound signals that are outputted. On the other hand, the microphone 462 converts collected sound signals into electrical signals. The audio circuit 460 receives and converts the electrical signals into audio data, and then outputs the audio data to the second processor 480. After the audio data is processed by the second processor 480, the audio data is sent to, for example, another terminal via the RF circuit 410 or outputted to the memory 420 for further processing. The audio circuit 460 can include an earphone jack to provide communication between a peripheral headphone and the mobile terminal 400.

The mobile terminal 400 can help the user receive requests, send information, and the like through a transmission module 470 (such as a Wi-Fi module). It provides the user with wireless broadband Internet access. Although the transmission module 470 is illustrated in the figure, it can be understood that the transmission module 470 does not belong to a necessary structure of the mobile terminal 400, and can be omitted as needed without changing the essence of the disclosure.

The second processor 480 is a control center of the mobile terminal 400, and is connected to all parts of an entirety of the mobile phone by various interfaces and lines, and by running or executing software programs and/or modules stored in the memory 420, and calling data stored in the memory 420, performs various functions of the mobile terminal 400 and process the data to monitor the mobile terminal as a whole. Optionally, the second processor 480 can include one or more processing cores. In some embodiments, the second processor 480 can integrate an application processor and a modem processor. The application processor mainly processes an operating system, a user interface, application programs, etc., and the modem processor mainly processes wireless communications. It can be understood that the modem processor can also not be integrated into the second processor 480.

The mobile terminal 400 further includes a power source 490 (such as a battery) for supplying power to all components. In some embodiments, the power source can be logically connected to the second processor 480 through a power management system, to achieve, by the power management system, functions such as charging and discharging management, and power consumption management. The power source 490 can further include arbitrary components such as one or more direct current (DC) or alternating current (AC) power sources, a recharging system, a power failure detection circuit, a power converter or inverter, and a power status indicator.

The mobile terminal 400 further include cameras (such as a front camera, and a rear camera), a Bluetooth module, a flashlight, etc., although not illustrated. Details are omitted here. Specifically, in the present embodiments, the display unit of the mobile terminal 400 is a touch screen display.

In addition to the foregoing embodiments, the present disclosure can also have other embodiments. Any technical solutions formed by equivalent replacements fall within the scope of protection claimed in the present disclosure.

In summary, although the present disclosure has been described with the preferred embodiments thereof above, it is not intended to be limited by the foregoing preferred embodiments. Persons skilled in the art can carry out many changes and modifications to the described embodiments without departing from the scope and the spirit of the present disclosure. Thus, the protection scope of the present disclosure is in accordance with the scope defined by the claims.

1. A method for generating a chromaticity calibration compensation table, wherein the chromaticity calibration compensation table is applied to a display panel, and the generation method is applied to a first processor, wherein the display panel has a plurality of pixel units, and each of the pixel units has a plurality of primary color sub-pixels, and wherein the generation method at least comprises:
an acquisition step of acquiring luminance information of the display panel, wherein the luminance information at least comprises a mapping relationship and a plurality of predetermined luminance data, wherein the mapping relationship is between a plurality of pieces of actual chromaticity information and output grayscales of each of the primary color sub-pixels, comprising:
measuring pieces of primary color chromaticity information that each of the primary color sub-pixels has when each of the primary color sub-pixels individually displays the output grayscales that each of the primary color sub-pixels is configured with;
respectively selecting and adding one piece of the pieces of the primary color chromaticity information of each of the primary color sub-pixels together multiple times, to obtain the mapping relationship between the pieces of the actual chromaticity information and the output grayscales of each of the primary color sub-pixels; and
using the mapping relationship as the luminance information of the display panel;
a calculation step of, according to predetermined color information in a predetermined chromaticity system, and the predetermined luminance data, calculating a plurality of pieces of ideal chromaticity information that the display panel should have when the display panel displays a plurality of target grayscales with an ideal display effect; and
a generating step of matching the pieces of the actual chromaticity information and the pieces of the ideal chromaticity information to generate the chromaticity calibration compensation table, wherein the chromaticity calibration compensation table indicates the output grayscale that each of the primary color sub-pixels should be configured with when the display panel displays each of the target grayscales with the ideal display effect;
wherein the first processor at least comprises a calculation module, and an acquisition module and a generation module coupled to the calculation module, wherein the acquisition module is configured to perform the acquisition step, the calculation module is configured to perform the calculation step, and the generation module is configured to perform the generation step,
wherein the output grayscales have more levels than the target grayscales.

2. (canceled)

3. The generation method of claim 1, wherein the output grayscales comprise a plurality of selected output grayscales and a plurality of interpolation output grayscales, wherein each adjacent two of the selected output grayscales are spaced apart by at least one of the interpolation output grayscales, and wherein the step of measuring pieces of primary color chromaticity information that each of the primary color sub-pixels has when each of the primary color sub-pixels individually displays the output grayscales that each of the primary color sub-pixels is configured with specifically comprises:
measuring pieces of first primary color chromaticity information that each of the primary color sub-pixels has when each of the primary color sub-pixels individually displays the selected output grayscales that each of the primary color sub-pixels is configured with;
according to the pieces of the first primary color chromaticity information, deriving pieces of second primary color chromaticity information that each of the primary color sub-pixels has when each of the primary color sub-pixels individually displays the interpolation output grayscales that each of the primary color sub-pixels is configured with.

4. The generation method of claim 1, wherein each piece of the pieces of the primary color chromaticity information comprises a first stimulus value, a second stimulus value, and a third stimulus value, and wherein after the one piece of the pieces of the primary color chromaticity information of each of the primary color sub-pixels is respectively selected each time, the first stimulus value, the second stimulus value, and the third stimulus value in each piece of pieces of the primary color chromaticity information are added together in a one-to-one correspondence manner to acquire an actual first stimulus value, an actual second stimulus value, and an actual third stimulus value that are used as a piece of the actual chromaticity information.

5. The generation method of claim 1, wherein the step of acquiring luminance information of the display panel further comprises:
respectively acquiring a plurality of pieces of anchor chromaticity information of the display panel when the display panel is in full white display and full black display; and
using anchor second stimulus values in the pieces of the anchor chromaticity information as the predetermined luminance data in the luminance information of the display panel.

6. The generation method of claim 4, wherein the step of, according to predetermined color information in a predetermined chromaticity system, and the predetermined luminance data, calculating a plurality of pieces of ideal chromaticity information that the display panel should have when the display panel displays a plurality of target grayscales with an ideal display effect specifically comprises:
applying a first predetermined formula to the predetermined luminance data to calculate an ideal second stimulus value that the display panel should be configured with when the display panel displays each of the target grayscales with the ideal display effect;
applying second predetermined formulae to the predetermined color information in the predetermined chromaticity system and each of the ideal second stimulus values to calculate an ideal first stimulus value and an ideal third stimulus value corresponding to each of the ideal second stimulus values; and
using a plurality of sets of the corresponding ideal first stimulus values, ideal second stimulus values, and ideal third stimulus values as the pieces of the ideal chromaticity information, wherein the display panel has one piece of the pieces of the ideal chromaticity information when the display panel displays each of the target grayscales with the ideal display effect.

7. The generation method of claim 6, wherein before the step of matching the pieces of the actual chromaticity information and the pieces of the ideal chromaticity information, the generation method further comprises:
according to the actual first stimulus value, the actual second stimulus value, and the actual third stimulus value in each piece of the pieces of the actual chromaticity information, calculating a corresponding piece of actual color information; and
calculating a first difference between the piece of the actual color information of each piece of the pieces of the actual chromaticity information and the predetermined color information.

8. The generation method of claim 7, wherein before the step of matching the pieces of the actual chromaticity information and the pieces of the ideal chromaticity information, the generation method further comprises:
performing subtraction in a one-to-one correspondence manner between the actual first stimulus value, the actual second stimulus value, and the actual third stimulus value in each piece of the pieces of the actual chromaticity information and the ideal first stimulus value, the ideal second stimulus value, and the ideal third stimulus value in each piece of the pieces of the ideal chromaticity information, to obtain second differences.

9. The generation method of claim 8, in the step of matching the pieces of the actual chromaticity information and the pieces of the ideal chromaticity information, when there are a plurality of pieces of the actual chromaticity information that match a piece of the ideal chromaticity information, a piece of the actual chromaticity information with the first difference that is less is preferentially selected, and a piece of the actual chromaticity information with the second differences that are less is secondly selected.

10. A mobile terminal, wherein the mobile terminal at least comprises:
a display panel; and
a second processor coupled to the display panel, and configured to perform chromaticity calibration compensation operations on the display panel according to the chromaticity calibration compensation table of claim 1.

11. (canceled)

12. A mobile terminal, wherein the mobile terminal at least comprises:
a display panel; and
a second processor coupled to the display panel, and configured to perform chromaticity calibration compensation operations on the display panel according to the chromaticity calibration compensation table of claim 3.

13. A mobile terminal, wherein the mobile terminal at least comprises:
a display panel; and
a second processor coupled to the display panel, and configured to perform chromaticity calibration compensation operations on the display panel according to the chromaticity calibration compensation table of claim 4.

14. A mobile terminal, wherein the mobile terminal at least comprises:
a display panel; and
a second processor coupled to the display panel, and configured to perform chromaticity calibration compensation operations on the display panel according to the chromaticity calibration compensation table of claim 5.

15. A mobile terminal, wherein the mobile terminal at least comprises:
a display panel; and
a second processor coupled to the display panel, and configured to perform chromaticity calibration compensation operations on the display panel according to the chromaticity calibration compensation table of claim 6.

16. A mobile terminal, wherein the mobile terminal at least comprises:
a display panel; and
a second processor coupled to the display panel, and configured to perform chromaticity calibration compensation operations on the display panel according to the chromaticity calibration compensation table of claim 7.

17. A mobile terminal, wherein the mobile terminal at least comprises:
a display panel; and
a second processor coupled to the display panel, and configured to perform chromaticity calibration compensation operations on the display panel according to the chromaticity calibration compensation table of claim 8.

18. A mobile terminal, wherein the mobile terminal at least comprises:
a display panel; and
a second processor coupled to the display panel, and configured to perform chromaticity calibration compensation operations on the display panel according to the chromaticity calibration compensation table of claim 9.

19. The generation method of claim 1, wherein a number of levels of the output grayscales is 2^{N} times a number of levels of the target grayscales.

20. A mobile terminal, wherein the mobile terminal at least comprises:
a display panel; and
a second processor coupled to the display panel, and configured to perform chromaticity calibration compensation operations on the display panel according to the chromaticity calibration compensation table of claim 19.
